(19) United States
(12) Patent Application Publication
(10) Pub. No.: US 2015/0302275 A1
(43) Pub. Date: Oct. 22, 2015

(54) Devices, Terminals and Methods for Image Acquisition

(71) Applicant: Tencent Technology (Shenzhen) Company Limited, Shenzhen (CN)

(72) Inventor: Haizhen Liao, Shenzhen (CN)

(21) Appl. No.: 14/753,109

(22) Filed: Jun. 29, 2015

Related U.S. Application Data
(63) Continuation of application No. PCT/CN2014/080704, filed on Jun. 25, 2014.

(30) Foreign Application Priority Data
Jul. 24, 2013 (CN) 201310314013.1

(51) Int. Cl. G06K 9/62; H04N 5/232

(52) U.S. Cl. CPC G06K 9/6215; H04N 5/23293

(57) ABSTRACT

Devices, terminals and methods are provided for image acquisition. For example, an instruction for acquiring a first image triggered by a user is responded to; actual feature information of the first image is acquired; preset feature information of a reference image corresponding to the first image is called; the actual feature information of the first image is compared with the preset feature information of the reference image; a first similarity between the actual feature information of the first image and the preset feature information of the reference image is determined; and image acquisition is performed for the first image based on at least information associated with the first similarity.

### CROSS-REFERENCES TO RELATED APPLICATIONS

The application claims priority to Chinese Patent Application No. 201310314013.1, filed Jul. 24, 2013, incorporated by reference herein for all purposes.

### BACKGROUND OF THE INVENTION

Certain embodiments of the present invention are directed to computer technology. More particularly, some embodiments of the invention provide systems and methods for data processing. Merely by way of example, some embodiments of the invention have been applied to image acquisition. But it would be recognized that the invention has a much broader range of applicability.

Currently, different image processing approaches are often used by an image acquisition tool on a terminal for image acquisition or processing of acquired images. For example, an image acquisition tool usually supports black-and-white image processing, dot matrix image processing, sketch image processing, fuzzy image processing, etc. In another example, the image acquisition tool performs beautification processing for images using preset materials. The above-noted image processing approaches are often used based on an original design of an image. In photography, a subject often needs to be set up according to a predetermined design before a photo is shot. For example, an overall design of subjects for a group photo shows two simple letters KO. A photographer may arbitrarily guide different people to respective designated positions and then shoot a photo. As the photographer does not know in advance the difference between the poses of the subjects and the predetermined overall design, actual effects of the photo may not be consistent with what is anticipated.

Hence it is highly desirable to improve the techniques for image acquisition.

### BRIEF SUMMARY OF THE INVENTION

According to one embodiment, a method is provided for image acquisition. For example, an instruction for acquiring a first image triggered by a user is responded to; actual feature information of the first image is acquired; preset feature information of a reference image corresponding to the first image is called; the actual feature information of the first image is compared with the preset feature information of the reference image; a first similarity between the actual feature information of the first image and the preset feature information of the reference image is determined; and image acquisition is performed for the first image based on at least information associated with the first similarity.

According to another embodiment, an image acquisition device includes: an instruction response module configured to respond to an instruction for acquiring a first image triggered by a user and acquire actual feature information of the first image; an information acquisition module configured to call preset feature information of a reference image corresponding to the first image, compare the actual feature information of the first image with the preset feature information of the reference image, and determine a first similarity between the actual feature information of the first image and the preset feature information of the reference image; and an image acquisition module configured to perform image acquisition for the first image based on at least information associated with the first similarity.

According to yet another embodiment, an image acquisition terminal includes: an image acquisition device. The image acquisition device includes: an instruction response module configured to respond to an instruction for acquiring a first image triggered by a user and acquire actual feature information of the first image; an information acquisition module configured to call preset feature information of a reference image corresponding to the first image, compare the actual feature information of the first image with the preset feature information of the reference image, and determine a first similarity between the actual feature information of the first image and the preset feature information of the reference image; and an image acquisition module configured to perform image acquisition for the first image based on at least information associated with the first similarity.

According to yet another embodiment, a non-transitory computer readable storage medium includes programming instructions for image acquisition. The programming instructions are configured to cause one or more data processors to execute certain operations. For example, an instruction for acquiring a first image triggered by a user is responded to; actual feature information of the first image is acquired; preset feature information of a reference image corresponding to the first image is called; the actual feature information of the first image is compared with the preset feature information of the reference image; a first similarity between the actual feature information of the first image and the preset feature information of the reference image is determined; and image acquisition is performed for the first image based on at least information associated with the first similarity.

For example, the devices, terminals and methods described herein are configured to use preset feature information as reference to guide a terminal for image acquisition to improve accuracy and efficiency of image acquisition and avoid repeated image acquisition for a same image.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for image acquisition according to one embodiment of the present invention.

FIG. 2 is a simplified diagram showing a method for image acquisition according to another embodiment of the present invention.

FIG. 3 is a simplified diagram showing a method for image acquisition according to yet another embodiment of the present invention.

FIG. 4 is a simplified diagram showing a device for image acquisition according to one embodiment of the present invention.

FIG. 5 is a simplified diagram showing a terminal for image acquisition according to one embodiment of the present invention.

### DETAILED DESCRIPTION OF THE INVENTION

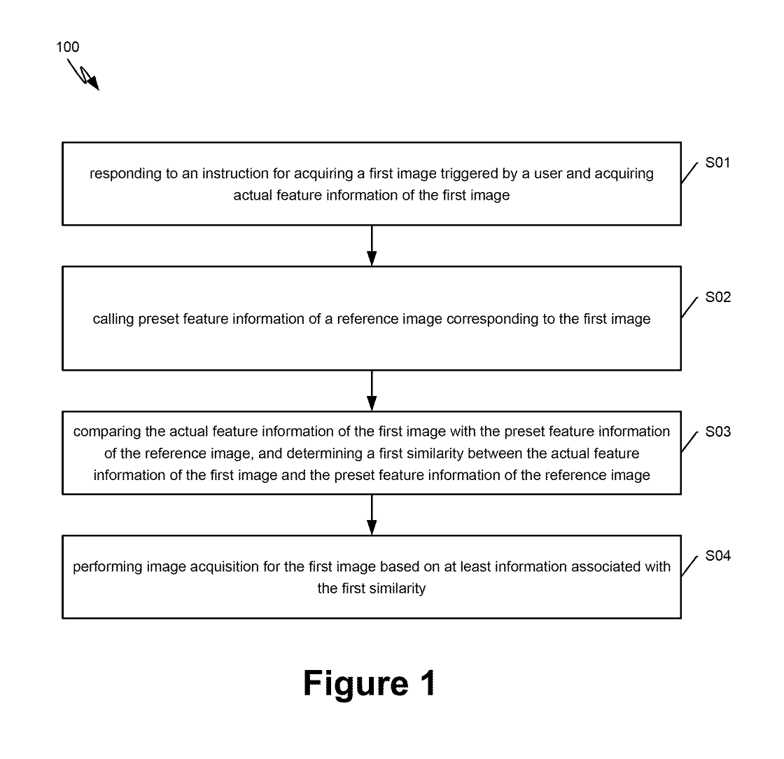

FIG. 1 is a simplified diagram showing a method for image acquisition according to one embodiment of the present invention. The diagram is merely an example, which should not unduly limit the scope of the claims. One of ordinary skill in the art would recognize many variations, alternatives, and modifications. The method 100 includes at least processes S01-S04.

According to one embodiment, the process S01 includes: responding to an instruction for acquiring a to-be-acquired image triggered by a user and acquiring actual feature information of the to-be-acquired image. For example, a terminal monitors the acquisition instruction triggered by the user in real time or at a certain time interval. In another example, upon detection of the instruction of acquiring the to-be-acquired image triggered by the user, the terminal responds to the instruction of acquiring the to-be-acquired image triggered by the user to determine the to-be-acquired image and acquires the actual feature information of the to-be-acquired image.

According to another embodiment, a user can enter a photographing function of a mobile phone through a physical key or a virtual key on the mobile phone to trigger an instruction of photographing a subject. For example, the mobile phone enters a photographing interface in response to the photographing instruction triggered by the user. As an example, on the photographing interface, the mobile phone can determine a subject in response to the photographing instruction and acquire basic features of one or more subjects, such as a pose of a person or a design of one or more objects. In another example, the subjects are shown on the photographing interface to the user.

According to yet another embodiment, the process S02 includes: calling preset feature information of a reference image corresponding to the to-be-acquired image. For example, the terminal calls the preset feature information of the reference image corresponding to the to-be-acquired image in response to user operations. The preset feature information of the reference image includes a shape or a design associated with the reference image input by the user, according to some embodiments. For example, the particular shapes or designs that the user wants to use to acquire the to-be-acquired image are called so that the to-be-acquired image acquired by the terminal can show the corresponding shapes or designs. As an example, if the user needs to take an O-shaped group photograph, the user inputs the corresponding feature information. Then, the terminal calls the preset feature information of the O shape or the O design corresponding to the photographing of the group photograph in response to the user operations, according to certain embodiments.

In one embodiment, the process S03 includes: comparing the actual feature information of the to-be-acquired image with the preset feature information of the reference image, and determining a similarity between the actual feature information of the to-be-acquired image and the preset feature information of the reference image. For example, to acquire an image with the preset feature information, the terminal compares the actual feature information of the to-be-acquired image with the preset feature information of the reference image corresponding to the to-be-acquired image to determine a difference between the to-be-acquired image and the reference image. One or more elements in the to-be-acquired image are adjusted before acquisition to enable the to-be-acquired image to meet the acquisition requirements before the actual image acquisition and to avoid repeated acquisition operations. As an example, before a user takes a group photograph, poses of one or more persons related to the group photograph are adjusted through the comparison of the overall design of the reference image, so that the overall design of the group photograph is consistent with that of the reference image. The terminal determines the similarity between the actual feature information of the to-be-acquired image and the preset feature information by comparing the actual feature information of the to-be-acquired image with the preset feature information, and performs image acquisition according to the similarity so that the acquired image can have the preset feature information.

In another embodiment, the process S04 includes: performing image acquisition for the to-be-acquired image based on at least information associated with the similarity. For example, the terminal acquires the to-be-acquired image based on the similarity between the actual feature information of the to-be-acquired image and the preset feature information of the reference image. When the similarity between the actual feature information of the to-be-acquired image and the preset feature information of the reference image is smaller than a preset similarity threshold, the to-be-acquired image is adjusted based on at least information associated with a difference between the actual feature information and the preset feature information, according to some embodiments. For example, the actual feature information of the adjusted to-be-acquired image is compared with the preset feature information of the reference image again, and the to-be-acquired image is adjusted again until the similarity between the actual feature information of the to-be-acquired image and the preset feature information of the reference image is larger than or equal to the preset similarity threshold. As an example, if the similarity between the actual feature information of the to-be-acquired image and the preset feature information of the reference image cannot reach the preset similarity threshold after the to-be-acquired image is adjusted for a preset number of times, the terminal sends notification of an adjustment error to prompt the user whether to continue adjustment or continue the image acquisition process. As another example, the terminal directly performs image acquisition for a particular version of the adjusted to-be-acquired image that has a maximum similarity with the preset feature information of the reference image.

In yet another embodiment, image acquisition is performed for the to-be-acquired image directly when the similarity between the actual feature information of the to-be-acquired image and the preset feature information of the reference image reaches the preset similarity threshold. The terminal can store the acquired image according to user needs, according to some embodiments. For example, the terminal can store the image acquired according to the preset feature information of the reference image. In another example, the terminal directly stores an original image.

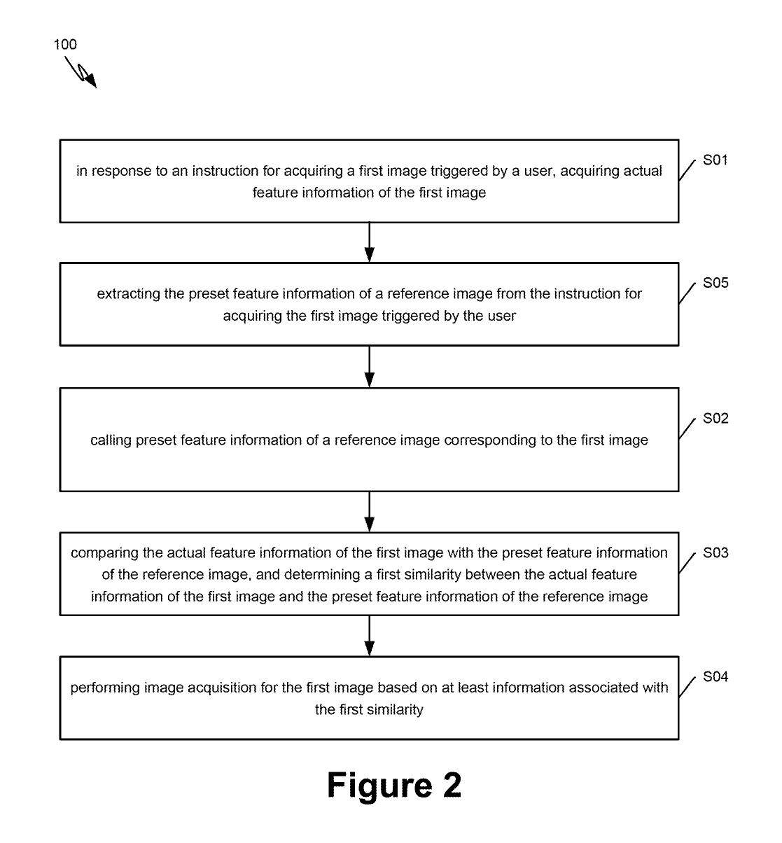

FIG. 2 is a simplified diagram showing a method for image acquisition according to another embodiment of the present invention. The diagram is merely an example, which should not unduly limit the scope of the claims. One of ordinary skill in the art would recognize many variations, alternatives, and modifications. The method 100 further includes at least a process S05.

According to one embodiment, the process S05 includes: extracting the preset feature information of the reference image from the instruction for acquiring the to-be-acquired image triggered by the user. For example, the terminal responds to the instruction of acquiring the to-be-acquired image triggered by the user and extracts the preset feature information of the reference image corresponding to the to-be-acquired image from the acquisition instruction, so as to use the acquired preset feature information of the reference image as reference and perform image acquisition for the to-be-acquired image.

According to another embodiment, the terminal can also acquire the preset feature information of the reference image in other manners. For example, the terminal analyzes the instruction of acquiring the to-be-acquired image triggered by the user to acquire an image needed by the user. In another example, the terminal searches a preset feature information storage database to find stored feature information with a highest matching degree with the image needed by the user, and takes the stored feature information as the preset feature information.

The terminal can acquire the preset feature information of the reference image according to the instruction triggered by the user or particular acquisition manners preset by the terminal, according to some embodiments. For example, the preset feature information of the reference image acquired by the terminal provides reference for the subsequent image acquisition. As an example, the terminal can acquire the preset feature information of the reference image in different manners according to different application scenarios to expand the applicable range of the terminal, enrich the functions of the terminal, and improve man-machine interactivity.

Referring to FIG. 1 and FIG. 2, if the preset feature information of the reference image corresponds to the shape of the to-be-acquired image, the process S03 for comparing the actual feature information of the to-be-acquired image with the preset feature information of the reference image, and identifying the similarity between the actual feature information of the to-be-acquired image and the preset feature information of the reference image involves the following, according to certain embodiments. For example, when the preset feature information of the reference image corresponds to the shape of the to-be-acquired image, the terminal adjusts an actual shape of the to-be-acquired image and a preset shape of the reference image to a same size, and normalizes into a same coordinate system on a user interface, so that the shapes of the two images are compared with the same size in the same coordinate system, and the actual shape of the to-be-acquired image is compatible with the preset shape of the reference image. To compare the actual shape of the to-be-acquired image with the preset shape of the reference image, the preset shape of the reference image can be displayed on the user interface according to a certain transparency setting parameter, according to some embodiments. For example, if the reference image is displayed translucently, the transparency setting parameter corresponds to 0.5. In another example, the transparency setting parameter is reduced so as not to affect the observation of the actual shape of the to-be-acquired image, and the preset shape of the reference image is displayed with the transparency setting parameter corresponding to 0.2. The similarity between the actual shape of the to-be-acquired image and the preset shape of the reference image can be compared visually and clearly, and image acquisition is performed for the to-be-acquired image according to the similarity between the actual shape of the to-be-acquired image and the preset shape of the reference image, in some embodiments.

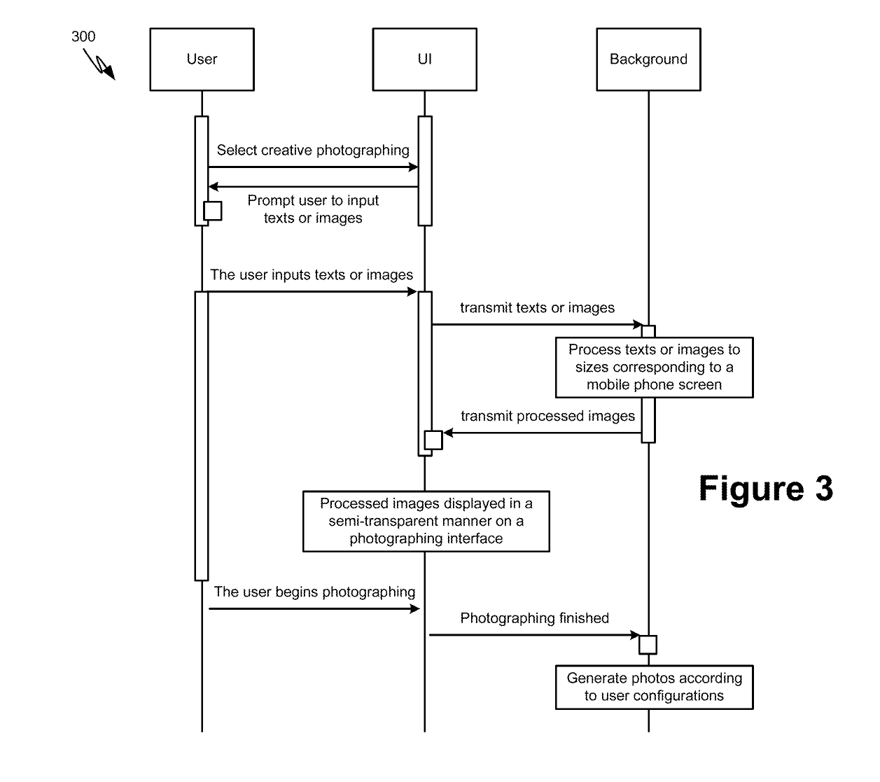

FIG. 3 is a simplified diagram showing a method for image acquisition according to yet another embodiment of the present invention. The diagram is merely an example, which should not unduly limit the scope of the claims. One of ordinary skill in the art would recognize many variations, alternatives, and modifications.

According to one embodiment, the method 300 is applied to a particular application scenario where an intelligent mobile phone photographs a human body according to a certain shape or a certain pose. For example, the user presses a creative photographing function button on the intelligent mobile phone to enter a creative photographing application. In another example, through a user interface (UI), the mobile phone prompts the user to input text information or image information as reference information for subsequent creative photographing. In yet another example, the user inputs the text information or image information, such as an image including capital letters KO, as the creative photographing design to the UI. In yet another example, the UI of the mobile phone sends the image including the capital letters KO to a background processing program of the mobile phone. As an example, the background processing program of the mobile phone performs logic processing of the input image so that the image can be displayed according to preset scale dimension and a transparency parameter on the screen of the mobile phone. The processed image is displayed on the UI for the user, in some embodiments. Then, the user begins photographing, compares an overall design of a group with the design of KO shown on a photographing interface, and adjusts respective positions of people in the group photograph according to user needs, so that the user can obtain a group photograph with the KO design. For example, based on the user's configurations, the mobile phone can generate photographs with creativity or original photographs without creativity for the user to select. In another example, the user can photograph normally without pressing the creative photographing function button. The method 300 is applied to avoid repeated photographing and improve man-machine interactivity, according to certain embodiments.

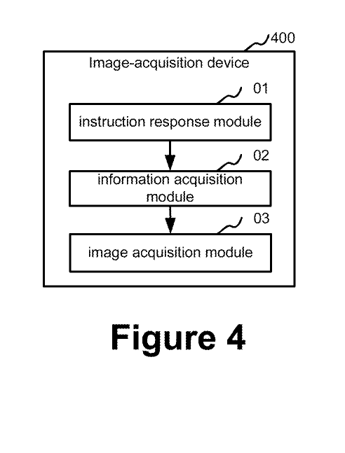

FIG. 4 is a simplified diagram showing a device for image acquisition according to one embodiment of the present invention. The diagram is merely an example, which should not unduly limit the scope of the claims. One of ordinary skill in the art would recognize many variations, alternatives, and modifications. The image acquisition device 400 includes: an instruction response module 01, an information acquisition module 02 and an image acquisition module 03.

According to one embodiment, the instruction response module 01 is configured to respond to an instruction of acquiring a to-be-acquired image triggered by a user, and acquire actual feature information of the to-be-acquired image. For example, the instruction response module 01 monitors the acquisition instruction triggered by the user in real time or at an interval. In another example, upon detection of the instruction of acquiring the to-be-acquired image triggered by the user, the instruction response module 01 responds to the instruction of acquiring the to-be-acquired image triggered by the user to determine the to-be-acquired image and acquire the actual feature information of the to-be-acquired image.

According to another embodiment, a user can enter a photographing function of a mobile phone through a physical key or a virtual key on the mobile phone to trigger an instruction of photographing a subject. For example, the mobile phone enters a photographing interface in response to the photographing instruction triggered by the user. As an example, on the photographing interface, the mobile phone can determine a subject in response to the photographing instruction and acquire basic features of one or more subjects, such as a pose of a person or a design of one or more objects. In another example, the subjects are shown on the photographing interface to the user.

According to yet another embodiment, the information acquisition module 02 is configured to call preset feature information of a reference image corresponding to the to-be-acquired image, compare the actual feature information of the to-be-acquired image with the preset feature information of the reference image, and determine a similarity between the actual feature information of the to-be-acquired image and the preset feature information of the reference image. For example, the information acquisition module 02 calls the preset feature information of the reference image corresponding to the to-be-acquired image according to user operations. The preset feature information of the reference image includes a shape or a design associated with the reference image input by the user, according to some embodiments. For example, the particular shapes or designs that the user wants to use to acquire the to-be-acquired image are called so that the to-be-acquired image acquired by the terminal can show the corresponding shapes or designs. As an example, if the user needs to take an O-shaped group photograph, the user inputs the corresponding feature information. Then, the terminal calls the preset feature information of the O shape or the O design corresponding to the photographing of the group photograph in response to the user operations, according to certain embodiments.

In one embodiment, to acquire the image with the preset feature information, the information acquisition module 02 compares the actual feature information of the first image with the preset feature information of the reference image to determine a difference between the first image and the reference image. One or more elements in the to-be-acquired image are adjusted before acquisition to enable the to-be-acquired image to meet the acquisition requirements before the actual image acquisition and to avoid repeated acquisition operations. As an example, before a user takes a group photograph, poses of one or more persons related to the group photograph are adjusted through the comparison of the overall design of the reference image, so that the overall design of the group photograph is consistent with that of the reference image. In another example, the information acquisition module 02 determines the similarity between the actual feature information of the first image and the preset feature information of the reference image by comparing the actual feature information of the first image with the preset feature information of the reference image, and performs image acquisition according to the similarity so that the acquired image can have the preset feature information.

In another embodiment, the image acquisition module 03 is configured to perform image acquisition for the to-be-acquired image based on at least information associated with the similarity. For example, the image acquisition module 03 acquires the image according to the similarity between the actual feature information of the first image and the preset feature information of the reference image. As an example, if the similarity between the actual feature information of the first image and the preset feature information of the reference image is smaller than a preset similarity threshold, the image acquisition module 03 adjusts the to-be-acquired image according to the difference between the actual feature information and the preset feature information, compares the actual feature information of the adjusted to-be-acquired image with the preset feature information of the reference image again, and adjusts the to-be-acquired image until the similarity between the actual feature information of the to-be-acquired image and the preset feature information of the reference image is larger than or equal to the preset similarity threshold.

In yet another embodiment, if the similarity between the actual feature information of the to-be-acquired image and the preset feature information of the reference image cannot reach the preset similarity threshold after the image acquisition module 03 adjusts the to-be-acquired image for a preset number of times, the image acquisition module 03 sends notification of an adjustment error to prompt the user whether to continue adjustment or continue the image acquisition process. For example, the image acquisition module 03 directly performs image acquisition for a particular version of the adjusted to-be-acquired image that has a maximum similarity with the preset feature information of the reference image.

In yet another embodiment, the image acquisition module 03 directly performs image acquisition for the to-be-acquired image when the similarity between the actual feature information of the to-be-acquired image and the preset feature information of the reference image reaches the preset similarity threshold. For example, the image acquisition module 03 can store the acquired image according to user needs, according to some embodiments. For example, the image acquisition module 03 can store the image acquired according to the preset feature information of the reference image. In another example, the image acquisition module 03 directly stores an original image.

According to one embodiment, the information acquisition module 02 is further configured to: extract the preset feature information of the reference image from the instruction of acquiring the to-be-acquired image triggered by the user. For example, the information acquisition module 02 extracts the preset feature information of the reference image corresponding to the to-be-acquired image from the acquisition instruction after the instruction response module 01 responds to the instruction of acquiring the to-be-acquired image triggered by the user, so as to acquire the to-be-acquired image by taking the preset feature information of the reference image as reference. The information acquisition module 02 can also acquire the preset feature information of the reference image in other manners, according to some embodiments. For example, the information acquisition module 02 analyzes the instruction of acquiring the to-be-acquired image triggered by the user to acquire an image needed by the user. In another example, the information acquisition module 02 searches a preset feature information storage database to find stored feature information with a highest matching degree with the image needed by the user, and takes the stored feature information as the preset feature information.

The information acquisition module 02 can acquire the preset feature information of the reference image according to the instruction triggered by the user or particular acquisition manners preset by the terminal, according to some embodiments. For example, the preset feature information of the reference image acquired by the information acquisition module 02 provides reference for the subsequent image acquisition. As an example, the information acquisition module 02 can acquire the preset feature information of the reference image in different manners according to different application scenarios to expand the applicable range of the device 400, enrich the functions of the device 400, and improve man-machine interactivity.

According to some embodiments, if the preset feature information of the reference image corresponds to the shape of the to-be-acquired image, the information acquisition module 02 adjusts an actual shape of the to-be-acquired image and a preset shape of the reference image to a same size, and normalizes into a same coordinate system on a user interface, so that the shapes of the two images are compared with the same size in the same coordinate system, and the actual shape of the to-be-acquired image is compatible with the preset shape of the reference image. To compare the actual shape of the to-be-acquired image with the preset shape of the reference image, the information acquisition module 02 displays the preset shape of the reference image on the user interface according to a certain transparency setting parameter, according to certain embodiments. For example, if the reference image is displayed translucently, the transparency setting parameter corresponds to 0.5. In another example, the information acquisition module 02 reduces the transparency setting parameter so as not to affect the observation of the actual shape of the to-be-acquired image, and the preset shape of the reference image is displayed with the transparency setting parameter corresponding to 0.2. The similarity between the actual shape of the to-be-acquired image and the preset shape of the reference image can be compared visually and clearly, and the image acquisition module 03 performs image acquisition for the to-be-acquired image according to the similarity between the actual shape of the to-be-acquired image and the preset shape of the reference image, in some embodiments. The device 400 is implemented according to the method 300 as shown in FIG. 3, according to some embodiments.

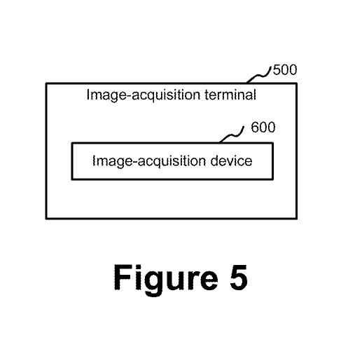

FIG. 5 is a simplified diagram showing a terminal for image acquisition according to one embodiment of the present invention. The diagram is merely an example, which should not unduly limit the scope of the claims. One of ordinary skill in the art would recognize many variations, alternatives, and modifications. The image acquisition terminal includes an image acquisition device 600.

According to one embodiment, the device 600 includes: an instruction response module configured to respond to an instruction for acquiring a first image triggered by a user and acquire actual feature information of the first image; an information acquisition module configured to call preset feature information of a reference image corresponding to the first image, compare the actual feature information of the first image with the preset feature information of the reference image, and determine a first similarity between the actual feature information of the first image and the preset feature information of the reference image; and an image acquisition module configured to perform image acquisition for the first image based on at least information associated with the first similarity. For example, the device 600 is the same as the device 400 as shown in FIG. 4.

According to one embodiment, a method is provided for image acquisition. For example, an instruction for acquiring a first image triggered by a user is responded to; actual feature information of the first image is acquired; preset feature information of a reference image corresponding to the first image is called; the actual feature information of the first image is compared with the preset feature information of the reference image; a first similarity between the actual feature information of the first image and the preset feature information of the reference image is determined; and image acquisition is performed for the first image based on at least information associated with the first similarity. For example, the method is implemented according to at least FIG. 1, FIG. 2 and/or FIG. 3.

According to another embodiment, an image acquisition device includes: an instruction response module configured to respond to an instruction for acquiring a first image triggered by a user and acquire actual feature information of the first image; an information acquisition module configured to call preset feature information of a reference image corresponding to the first image, compare the actual feature information of the first image with the preset feature information of the reference image, and determine a first similarity between the actual feature information of the first image and the preset feature information of the reference image; and an image acquisition module configured to perform image acquisition for the first image based on at least information associated with the first similarity. For example, the device is implemented according to at least FIG. 4.

According to yet another embodiment, an image acquisition terminal includes: an image acquisition device. The image acquisition device includes: an instruction response module configured to respond to an instruction for acquiring a first image triggered by a user and acquire actual feature information of the first image; an information acquisition module configured to call preset feature information of a reference image corresponding to the first image, compare the actual feature information of the first image with the preset feature information of the reference image, and determine a first similarity between the actual feature information of the first image and the preset feature information of the reference image; and an image acquisition module configured to perform image acquisition for the first image based on at least information associated with the first similarity. For example, the terminal is implemented according to at least FIG. 5.

According to yet another embodiment, a non-transitory computer readable storage medium includes programming instructions for image acquisition. The programming instructions are configured to cause one or more data processors to execute certain operations. For example, an instruction for acquiring a first image triggered by a user is responded to; actual feature information of the first image is acquired; preset feature information of a reference image corresponding to the first image is called; the actual feature information of the first image is compared with the preset feature information of the reference image; a first similarity between the actual feature information of the first image and the preset feature information of the reference image is determined; and image acquisition is performed for the first image based on at least information associated with the first similarity. For example, the storage medium is implemented according to at least FIG. 1, FIG. 2, and/or FIG. 3.

The above only describes several scenarios presented by this invention, and the description is relatively specific and detailed, yet it cannot therefore be understood as limiting the scope of this invention. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it is understood by those of skill in the art that there are other embodiments that are equivalent to the described embodiments. Accordingly, it is to be understood that the invention is not to be limited by the specific illustrated embodiments, but only by the scope of the appended claims.

1. An image acquisition method comprising:
responding to an instruction for acquiring a first image triggered by a user;
acquiring actual feature information of the first image;
calling preset feature information of a reference image corresponding to the first image;
comparing the actual feature information of the first image with the preset feature information of the reference image;
determining a first similarity between the actual feature information of the first image and the preset feature information of the reference image; and
performing image acquisition for the first image based on at least information associated with the first similarity.

2. The method of claim 1 wherein the performing image acquisition for the first image based on at least information associated with the first similarity includes:
in response to the first similarity between the actual feature information of the first image and the preset feature information of the reference image being smaller than a preset similarity threshold,
adjusting the first image based on at least information associated with a difference between the actual feature information and the preset feature information; and
performing image acquisition for the adjusted first image; and
in response to the first similarity between the actual feature information of the first image and the preset feature information of the reference image being no smaller than the preset similarity threshold, performing image acquisition for the first image.

3. The method of claim 1, further comprising:
extracting the preset feature information of the reference image from the instruction for acquiring the first image triggered by the user.

4. The method of claim 1, wherein the preset feature information of the reference image includes a preset acquisition shape of the first image.

5. The method of claim 4, wherein the comparing the actual feature information of the first image with the preset feature information of the reference image and the determining a first similarity between the actual feature information of the first image and the preset feature information of the reference image includes:
adjusting an actual shape of the first image and a preset shape of the reference image to a same size;
normalizing the actual shape of the first image and the preset shape of the reference image to a same coordinate system on a user interface;
displaying the preset acquisition shape of the first image provided by the reference image on the user interface based on at least information associated with a preset transparency parameter; and
determining a second similarity between the actual shape of the first image and the preset acquisition shape of the first image.

6. An image acquisition device comprising:
an instruction response module configured to respond to an instruction for acquiring a first image triggered by a user and acquire actual feature information of the first image;
an information acquisition module configured to call preset feature information of a reference image corresponding to the first image, compare the actual feature information of the first image with the preset feature information of the reference image, and determine a first similarity between the actual feature information of the first image and the preset feature information of the reference image; and
an image acquisition module configured to perform image acquisition for the first image based on at least information associated with the first similarity.

7. The device of claim 6, wherein the image acquisition module is further configured to:
in response to the first similarity between the actual feature information of the first image and the preset feature information of the reference image being smaller than a preset similarity threshold,
adjust the first image based on at least information associated with a difference between the actual feature information and the preset feature information; and
perform image acquisition for the adjusted first image; and
in response to the first similarity between the actual feature information of the first image and the preset feature information of the reference image being no smaller than the preset similarity threshold, perform image acquisition for the first image.

8. The device of claim 6, wherein the information acquisition module is further configured to:
extract the preset feature information of the reference image from the instruction for acquiring the first image triggered by the user.

9. The device of claim 6, wherein the preset feature information of the reference image includes a preset acquisition shape of the first image.

10. The device of claim 9, wherein the information acquisition module is further configured to:
adjust an actual shape of the first image and a preset shape of the reference image to a same size;
normalize the actual shape of the first image and the preset shape of the reference image to a same coordinate system on a user interface;
display the preset acquisition shape of the first image provided by the reference image on the user interface based on at least information associated with a preset transparency parameter; and
determine a second similarity between the actual shape of the first image and the preset acquisition shape of the first image.

11. The device of claim 6, further comprising:
one or more data processors; and
a computer-readable storage medium;
wherein one or more of the instruction response module, the information acquisition module, and the image acquisition module are stored in the storage medium and configured to be executed by the one or more data processors.

12. An image acquisition terminal comprising:
an image acquisition device including:
an instruction response module configured to respond to an instruction for acquiring a first image triggered by a user and acquire actual feature information of the first image;
an information acquisition module configured to call preset feature information of a reference image corresponding to the first image, compare the actual feature information of the first image with the preset feature information of the reference image, and determine a first similarity between the actual feature information of the first image and the preset feature information of the reference image; and
an image acquisition module configured to perform image acquisition for the first image based on at least information associated with the first similarity.

13. The terminal of claim 12, wherein the image acquisition module is further configured to:
in response to the first similarity between the actual feature information of the first image and the preset feature information of the reference image being smaller than a preset similarity threshold,
adjust the first image based on at least information associated with a difference between the actual feature information and the preset feature information; and
perform image acquisition for the adjusted first image; and
in response to the first similarity between the actual feature information of the first image and the preset feature information of the reference image being no smaller than the preset similarity threshold, perform image acquisition for the first image.

14. The terminal of claim 12, wherein the information acquisition module is further configured to:
extract the preset feature information of the reference image from the instruction for acquiring the first image triggered by the user.

15. The terminal of claim 12, wherein the preset feature information of the reference image includes a preset acquisition shape of the first image.

16. The terminal of claim 12, wherein the information acquisition module is further configured to:
adjust an actual shape of the first image and a preset shape of the reference image to a same size;
normalize the actual shape of the first image and the preset shape of the reference image to a same coordinate system on a user interface;
display the preset acquisition shape of the first image provided by the reference image on the user interface based on at least information associated with a preset transparency parameter; and
determine a second similarity between the actual shape of the first image and the preset acquisition shape of the first image.

17. (canceled)
